(19) United States
(12) Patent Application Publication
(10) Pub. No.: US 2011/0019856 A1
(43) Pub. Date: Jan. 27, 2011

(54) BOUNDARY MICROPHONE

(76) Inventor: Noriko Matsui, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/839,690

(22) Filed: Jul. 20, 2010

(30) Foreign Application Priority Data
Jul. 22, 2009 (JP) 2009-171269

(51) Int. Cl. H04R 11/04

(52) U.S. Cl. 381/355

(57) ABSTRACT

A boundary microphone including: a base made of metal; a cover that is made of metal and has a plurality of holes through which a sound wave is guided; a microphone unit that is disposed on the base and converts sound into an electric signal; and a pressing material that presses the cover against the base. The cover has a flange portion on a peripheral portion. The pressing material presses the flange portion of the cover against the base make the flange portion of the cover surface to surface contact with the base.

### BACKGROUND OF THE INVENTION

1. Field of the Invention

The present invention relates to a boundary microphone that is mainly placed on a table upon use, and more specifically to a boundary microphone having a structure for improving shielding effect against electromagnetic waves.

2. Description of the Related Art

Boundary microphones are known that are mainly placed on a desk upon use. FIG. 11 illustrates an example of a conventional boundary microphone. A base 27 of the boundary microphone illustrated in FIG. 11 is formed of a flat piece of metal and can be fixed on a surface of a table or a floor. In an upper surface of the base 27, a cavity (dimple) for mounting a circuit board 28 and the like is formed. From the upper surface of the base 27, a column 21 integrally formed with the base 27 is erected, approximately in the center when viewing the base 27 from the plane direction. A later described cover 20 is connected to the base 27 via the column 21. In the column 21, a tapped hole 22 is formed from the upper end. For the base 27, the left side and the right side in FIG. 11 are the front side and the backside, respectively, and a wall is integrally formed at the back end of the base 27. A bush 24 is fitted into a hole that is formed through this wall. In the case of a boundary microphone installed in a conference room, the boundary microphone is installed on a desk or the like with the front side facing the participants. One end of a microphone cord 25 is passed through a center hole of the bush 24. The microphone cord 25 is generally a cord constituted of a two-core balanced output cord and a shielding wire wrapping around the two-core balanced output cord. The end portions of the above-described two-core signal cable and shielding wire constituting the microphone cord 25 are connected to a predetermined soldering land or the like on the later-described circuit board 28.

In the upper surface of the base 27, the circuit board 28 is secured to the approximately front half portion of the above-described cavity so as to plug the cavity. In the upper surface of the circuit board 28, a microphone unit 26 is mounted with the sound wave introducing port thereof facing forward. As the microphone unit 26, a capacitor microphone unit is generally used. The cover 20 for covering the whole upper surface of the base 27 including the microphone unit 26 and the circuit board 28 is put on the base 27. The cover 20 is made of a metallic material, as in the case of the base 27, and numerous openings for introducing sound waves to the microphone unit 26 are formed therein. As the material of the cover 20, generally, a punching metal is used, in which numerous holes are formed by punching. The cover 20 is press molded into a flat plate form which is then inverted and put on the upper surface of the base 27. In the cover 20, approximately in the center when viewing the cover 20 from the plane direction, a dimple is formed at a position corresponding to the column 21 of the base 27 and a hole is formed in the bottom of this dimple. A screw 23 as a fastening member is inserted into this hole, and the screw 23 is screwed into the tapped hole 22 formed in the column 21, so that the cover 20 is fastened to the base 27. The head of the screw 23 sinks into the inside of the dimple of the cover 20. A receiving portion for the peripheral portion of the cover 20 is formed in the periphery of the upper surface side of the base 27, and the receiving portion is designed so that the peripheral portion of the cover 20 can be in contact with the base 27 while the cover 20 is fastened to the base 27 with the screw 23 as described above.

As described above, the boundary microphone includes mainly two parts in appearance, i.e., the base 27 and the cover 20, and the internal components are incorporated in the internal space. The screw 23 inserted in the hole of the cover 20 is screwed into the tapped hole 22 of the base 27, and whereby the base 27 and the cover 20 are mutually fastened. The base 27 and the cover 20 are fastened together with one screw 23 approximately in the center of the cover 20 and the head of the screw 23 fits into the dimple of the cover 20.

In the internal space enclosed by the base 27 and the cover 20, electric circuits, such as an impedance converter, a tone control circuit, and an output circuit, as well as the microphone unit 26 and the circuit board 28 are incorporated. If electromagnetic waves enter these electric circuits from the outside, this electromagnetic waves are detected by a semiconductor element used in the impedance converter or the like, and is then mixed into a sound signal as a noise signal, thereby degrading the signal to noise ratio (S/N) at the microphone output. Accordingly, it is preferable that the connecting portions in the peripheral portions of the base 27 and the cover 20 are joined together without any gap so as to shield the internal components from electromagnetic waves coming from the outside. The reason is that if these connecting portions are not joined together properly and the base 27 and the cover 20 are in point contact with each other and there is a gap therebetween, high frequency noise will enter through this gap.

Unfortunately, the conventional boundary microphone has such a structure that the base 27 and the cover 20 tend to be in point contact with each other for the reason described below. The base 27 is typically manufactured using a zinc die casting method or the like and has an uneven casting surface. On the other hand, for the cover 20, a punching metal is typically used as the material as described above, and by press molding this, the cover is formed into a desired shape. However, the peripheral portion, which is electrically and mechanically in contact with the base 27, is not flat and there occur irregularities. Accordingly, if the cover 20 is directly put on the base 27 and is screwed thereinto with the screw 23, the base 20 and the cover 27 will be in point contact with each other.

Japanese Patent Application Publication No. 2009-100157 discloses an example of a boundary microphone having a structure capable of blocking high frequency waves entering a microphone unit. According to the invention disclosed in Japanese Patent Application Publication No. 2009-100157, the internal components are disposed in the space enclosed by the base and the cover and furthermore the internal components are enclosed by the base, the cover, the first metallic part, and the second metallic part whose peripheral portions are alternately overlapped. Thus, the electromagnetic waves which are to enter the internal components from the outside can be blocked more effectively. For example, even if a mobile phone is used extremely near the microphone, it is possible to prevent the electromagnetic wave from entering the internal components and also possible to prevent the occurrence of noise caused by the electromagnetic wave. The shielding effect can be further enhanced by overlapping the peripheral portions of the first metallic part and the second metallic part with each other on the inside and outside thereof and by disposing the internal components in a space enclosed by the first metallic part and the second metallic part.

Still, there is a room for further improvement for the shielding effect of the boundary microphone of the invention disclosed in Japanese Patent Application Publication No. 2009-100157 because the first metallic mesh and the second metallic mesh overlap with each other and a gap may be produced therebetween. The metallic meshes and a boundary plate can be partially electrically connected with a screw and the like, but their connection is not continuous. Thus, there is a room for further improvement for surely preventing electromagnetic waves from entering. Further, a metallic mesh has to be used and thus the cost therefor is required.

A conventional boundary microphone having a circular shape as illustrated in FIGS. 12 and 13 is available. In FIGS. 12 and 13, the circular boundary microphone mainly includes: a base 117 having a circular planer shape; a cover 120 having a shape of a lid with a circular planer shape; microphone units 116 installed on the base 117 and covered with the cover 120; a cord insertion hole 125 provided at a center position of the base 117 as viewed from the plane direction, through which an internal space covered by the cover 120 is communicated with the outside; an external connection cord 123 inserted through the cord insertion hole 125; a rubber plate 122 provided under the base 117; and a tubular shaft 124 fitted in the cord insertion hole 125.

The base 117 is provided with the cord insertion hole 125. The internal space covered by the cover 120 is communicated with the outside through the cord insertion hole 125. The cord insertion hole 125 is provided at the intersection point of the central axis lines of the three microphone units 116 that are radially arranged. The base 117 is made of a flat piece of metal and the rubber plate 122 provided thereunder serves as a supporting base therefor. The cover 120 is pressed by a pressing material 121 in the inner diameter direction thereof. An insertion hole for a screw 113 is provided at the center of the cover 120 as viewed from the plane direction. The cover 120 is fixed to the base 117 with the screw 113 being screwed into a tapped hole appropriately provided on the tubular shaft 124 through the insertion hole. A circuit board not illustrated is provided on the upper surface of the base 117.

The above described boundary microphone includes mainly three parts in appearance, i.e., the base 117, the cover 120, and the pressing material 121, and the internal components are incorporated in the internal space. The cover 120 in the conventional boundary microphone is a punching plate and has a hole thereon and the cover 120 and the base 117 are actually in point connection. Thus, a gap is formed therebetween. Therefore, the shielding effect requires improvement. Further, if the screw 113 becomes loose, the cover 120 is lifted from the base 117. In such a case, the cover 120 and the base 117 cannot surely be in electrical connection with each other and the shielding effect becomes unstable.

### SUMMARY OF THE INVENTION

An object of the present invention is to provide a boundary microphone that can surely prevent the entrance of electromagnetic waves with a structure in which no gap is produced at a connection point between the cover and the base so that shielding effect against electromagnetic waves does not fail. Further, the boundary microphone uses no electromagnetic wave shielding member such as a metallic mesh. Thus, the manufacturing cost can be lowered.

A boundary microphone according to an aspect of the present invention includes: a base made of metal; a cover that is made of metal and has a plurality of holes through which a sound wave is guided; a microphone unit that is provided on the base and converts sound into an electric signal; and a pressing material that presses the cover against the base. The cover has a flange portion on a peripheral portion. The pressing material presses the flange portion of the cover against the base to make the flange portion of the cover surface to surface contact with the base.

According to the present invention, the base and the cover made of metal can be in contact without any gaps. Thus, electromagnetic waves to enter the internal component from the outside can be more effectively blocked. Further, occurrence of noise due to the electromagnetic waves can be prevented. Thus, the shielding effect can be further improved. In addition, the manufacturing cost can be lowered because no shielding material is required to be incorporated.

### BRIEF DESCRIPTION OF THE DRAWINGS

FIG. 1 is an exploded cross-sectional view of an embodiment of a boundary microphone according to the present invention;

FIG. 2 is a cross-sectional view of the embodiment;

FIG. 3 is a top view of the embodiment with a cover removed;

FIG. 4 is a bottom view of the embodiment;

FIG. 5 is a bottom view of the embodiment in another operating state;

FIG. 6 is a top view of the embodiment in the operating state as shown in FIG. 5, illustrated in accordance with FIG. 3;

FIG. 7 is a top view illustrating the cover in the embodiment;

FIG. 8 is a top view schematically illustrating the embodiment in a used state;

FIG. 9 is a top view schematically illustrating the embodiment in another used state;

FIG. 10 is a top view schematically illustrating the embodiment in still another used state;

FIG. 11 is a cross-sectional view of a conventional boundary microphone;

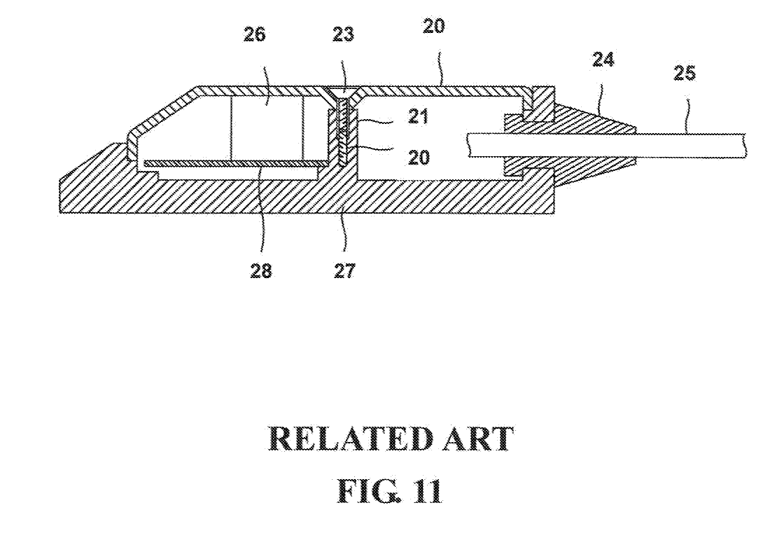

FIG. 12 is an exploded cross-sectional view of a conventional circular boundary microphone; and

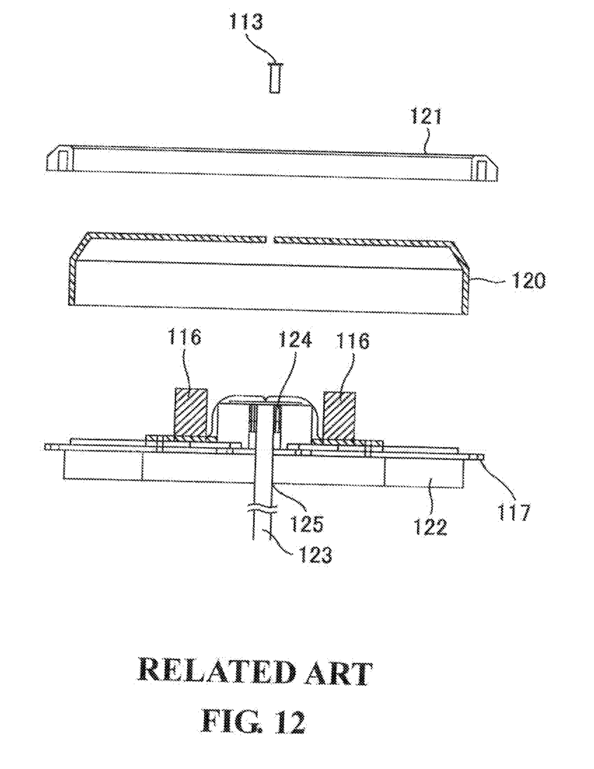

FIG. 13 is a cross-sectional view of the conventional boundary microphone.

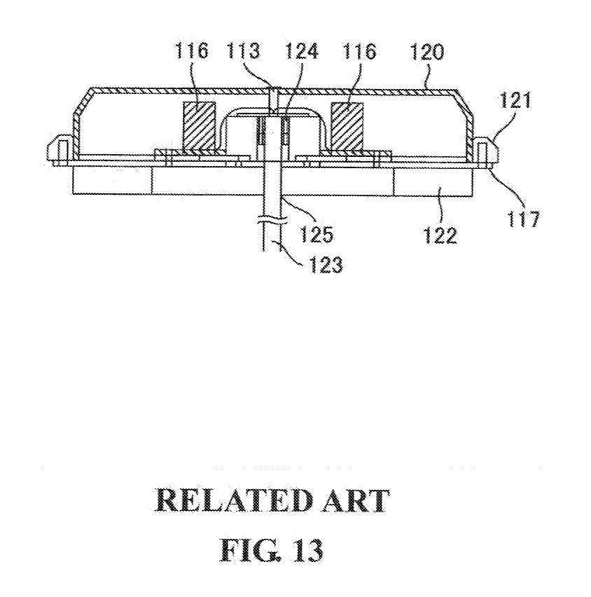

### DETAILED DESCRIPTION OF THE PREFERRED EMBODIMENTS

An embodiment of a boundary microphone according to the present invention is described below with reference to some of the accompanying drawings.

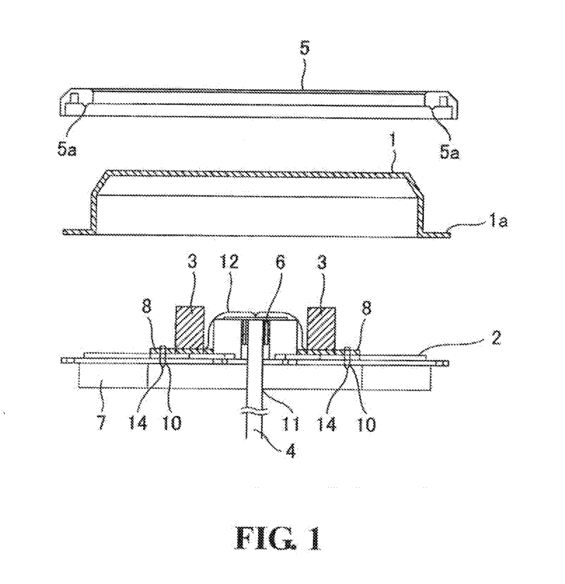

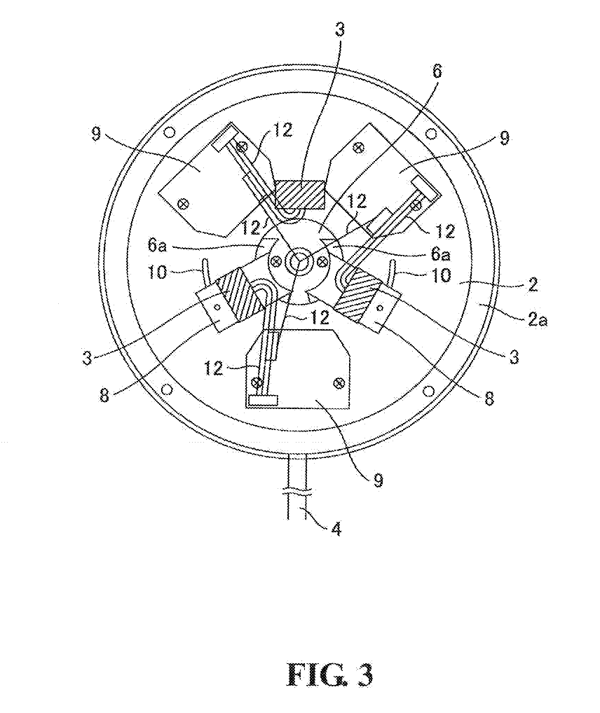

In FIGS. 1 to 3, a boundary microphone according to the present embodiment has a shape of a flat circular dish and mainly includes: a cover 1 having a flat flange portion 1a at the periphery on its opening end; a base 2 having a circular planer shape; a pressing material 5 having a shape of a ring; three microphone units 3; two microphone unit holders 8 each holding one of the microphone units 3 and being slidably installed on the base 2; knobs 14 each provided under the microphone unit holders 8; a circuit board 9 illustrated in FIG. 3; two holes 10 formed on the base 2, through which knobs 14 of the microphone unit holders 8 penetrate the base 2; a cord insertion hole 11 provided at a center position of the base 2 as viewed from the plane direction, through which the internal space covered by the cover 1 communicates with the outside; a pedestal 7 provided under the base 2; a tubular shaft 6 fitted in the cord insertion hole 11; a connection cord 4 for connecting with outside, inserted in the tubular shaft 6; and a wiring 12.

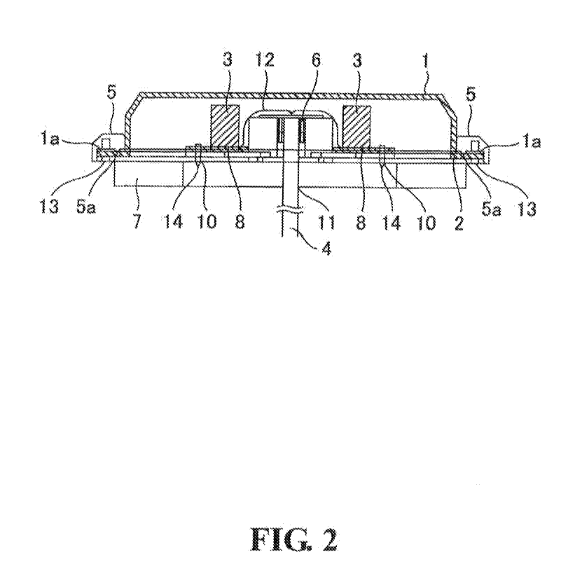

As illustrated in FIG. 2, the pressing material 5 having a shape of a ring presses the flange portion 1a of the cover 1 at the entire circumference thereof. The pressing member 5 has a protruding portion 5a at the bottom surface, i.e., the surface facing the flange portion 1a of the cover 1. The protruding portion 5a presses the flange portion 1a. The flange portion 1a of the cover 1 is pressed against the base 2 with the protruding portion 5a. The protruding portion 5a is continuously formed at the entire periphery of the pressing material 5. The base 2, the cover 1, and the pressing material 5 are integrally fastened with fastening members 13, e.g., screws.

In the boundary microphone configured as described above, the base 2 made of metal and the cover 1 are in surface connection and no gaps are produced at the peripheral portion. Further, with the pressing material 5 pressing the cover 1, the flange portion 1a of the cover 1 can be rigidly fixed on the upper surface of the base 2 at the peripheral portion. With the protruding portion 5a, the pressing force of the pressing material 5 is concentrated on the flange portion 1a of the cover 1. Thus, the flange portion 1a of the cover 1 can be more rigidly fixed on the upper surface of the base 2 at the peripheral portion through surface connection without producing any gaps. Thus, electromagnetic waves to enter the internal components from the outside can be more effectively blocked. Thus, the shielding effect is further improved and occurrence of noise due to electromagnetic waves can be prevented. In addition, the manufacturing cost can be saved as much as the cost for a shielding material not required to be incorporated.

As illustrated in FIG. 2, the tubular shaft 6 having a tubular shape is fitted in the cord insertion hole 11 of the base 2. The connection cord 4 for connecting with the outside is inserted in the tubular shaft 6. As illustrated in FIG. 3, the three microphone units 3 are provided around the tubular shaft 6 with their sound collecting surface facing outward in the radial direction of the base 2. Two of the three microphone units 3 are held by the respective microphone unit holders 8. The microphone unit holders 8 are so installed to be able to slide along a circular surface 6a formed on the tubular shaft 6 around the cord insertion hole 11, and move on a surface of the base 2 in an arc. Therefore, the two microphone units 3 held by the respective microphone unit holders 8 can also move in an arc around the cord insertion hole 11 together with the microphone unit holders 8 for a certain angular range. The remaining one microphone 3 is fixed on the base 2. The casing of each of the two microphone units 3 is electrically connected the base 2 via the microphone unit holder 8. The casing of the remaining microphone unit 3 is electrically connected to the base 2 directly, i.e., not via the microphone unit holder 8. Each of the microphone unit holders 8 slides while being in contact with the circular surface 6a of the tubular shaft 6. Thus, the microphone units 3 can move with their casing electrically connected to the base 2.

In the above described embodiment, the cord 4 is passed through the tubular shaft 6 towards the downward direction of the base 2. Thus, the cord 4 is not in the sound pickup range of the microphone units 3. Accordingly, sounds from a surrounding area can be efficiently picked up. The sliding mechanism of the microphone unit 3 is not limited to that illustrated and can be of any appropriate type. For example, a member for facilitating the sliding movement can be used.

The three microphone units 3 are so provided that the center axis lines thereof run parallel to the surface of the base 2. In an exemplary positioning, the two movable microphone units 3 are radially arranged around the cord insertion hole 11 with an angular interval of 120 degrees. The two microphone unit holders 8 hold the respective microphone units 3 with the angular interval therebetween maintained. As illustrated in FIGS. 1 and 2, the knobs 14 are integrally provided with the respective microphone unit holders 8 at the bottom surfaces thereof. The knobs 14 are integrally provided with the microphone unit holders 8 by an appropriate technique such as integral molding or by bonding. The two holes 10 through which the knobs 14 of the microphone unit holders 8 pass through are formed on the base 2. The movement of the microphone unit holders 8 around the cord insertion hole 11 is guided along the holes 10. The holes 10 are each formed in an arc around the cord insertion hole 11, and in a certain range so that the moving range of the microphone unit holders 8 is restricted.

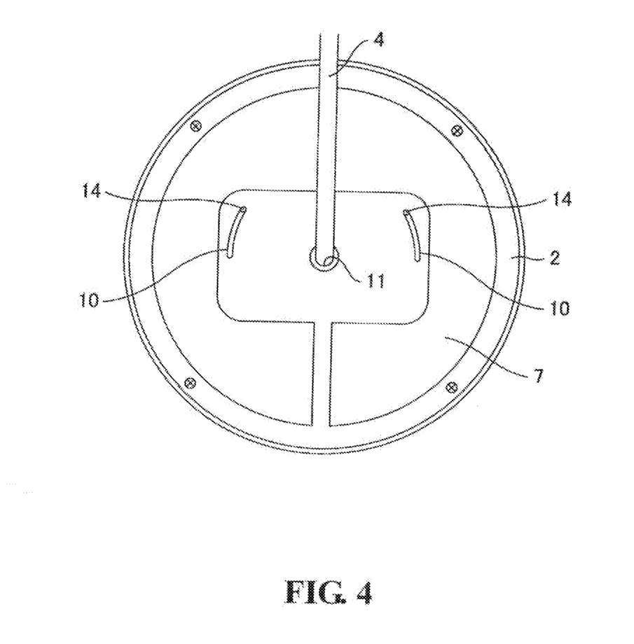

As illustrated in FIG. 4, the holes 10 are each formed as a slit in a shape of an arc around the cord insertion hole 11. The microphone units 3 can move together with the microphone unit holder 8 as the knobs 14 move at the bottom surface of the base 2 in the range defined by the holes 10. Thus, the hole 10, the microphone unit holder 8, and the knob 14 configure a microphone unit position changing unit.

The numbers of microphone unit 3 and the microphone unit holder 8, i.e., the number of microphone unit position changing unit in the boundary microphone according to the present invention can be arbitrarily set. For example, all three microphone units 3 can be radially arranged on the base 2 while being held by the respective microphone unit holders 8, and only one microphone unit 3 or all three microphone units 3 may be provided with the position changing unit. The number of holes 10 is set in accordance with the number of the microphone unit position changing unit. The knob 14 can be integrally molded with the microphone unit holder 8 or may be fixed thereon by means of, for example, adhesion.

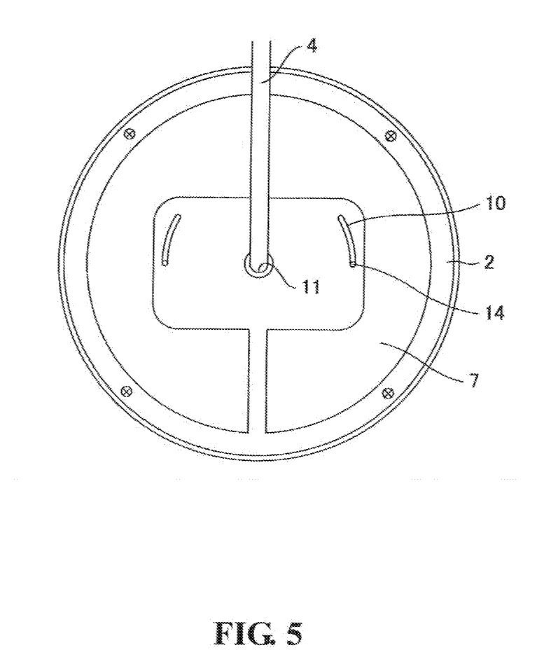

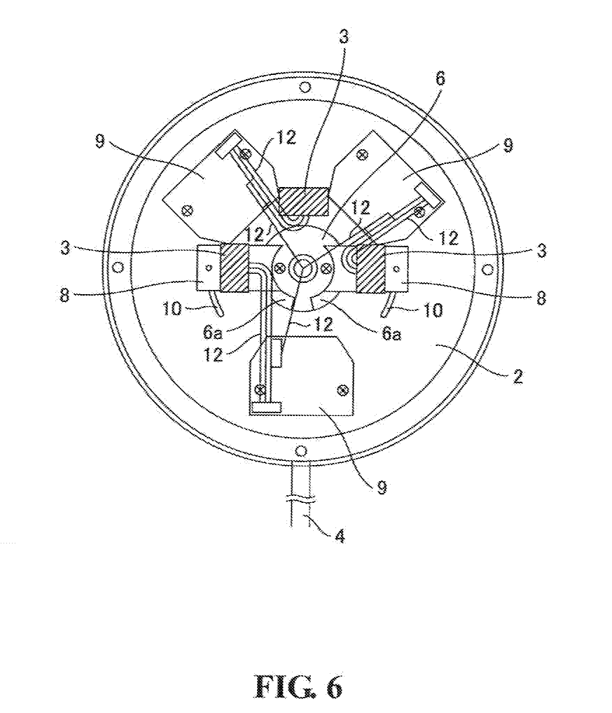

The three microphone units 3 are provided in a circumferential direction with angular intervals of 120 degrees as illustrated in FIG. 3 with the two knobs 14 each being positioned at an end of the hole 10 provided on the base 2. More specifically, the knob 14 on the right side in FIG. 4 is positioned at the movement limit position in the counter clockwise direction around the cord insertion hole 11, while the knob 14 on the left side in FIG. 4 is positioned at the movement limit position in the clockwise direction around the cord insertion hole 11. The two microphone units 3 held by the two respective microphone unit holders 8 are provided with the angular interval of 180 degrees in the circumferential direction as illustrated in FIG. 6 with the knobs 14 each being positioned at the other end of the hole 10 of the base 2 as illustrated in FIG. 5. That is, the microphone unit position changing units are so set that the center axis lines of the two microphone units 3 form a straight line. It is to be noted that, if two microphone units 3 each held by the respective microphone unit position changing units are positioned with an angular interval of 180 degrees, the remaining microphone unit 3 is so positioned that the center axial line thereof is perpendicular to the straight line connecting the centers of the two microphone units 3.

The number of the circuit boards 9 provided on the base 2 is as same as that of the microphone units 3. The circuit boards 9 are each fixed at a position between the microphone units 3. The microphone units 3, the circuit boards 9, and the cord 4 are electrically connected via the appropriate wiring 12 so as to be able to be in connection with an external output and so that power can be supplied thereto. In the boundary microphone having above described structure, the range in which the sound can be collected can be easily adjusted by operating the knob 14 composing the microphone unit position changing unit. The circuit boards 9 and the wirings 12 can be disposed at any positions as long as the movement of the microphone unit holder 8 is not interfered. For example, if three microphone units 3 are disposed as in the illustrated embodiment, preferably, three circuit boards 9 are radially provided around the cord insertion hole 11.

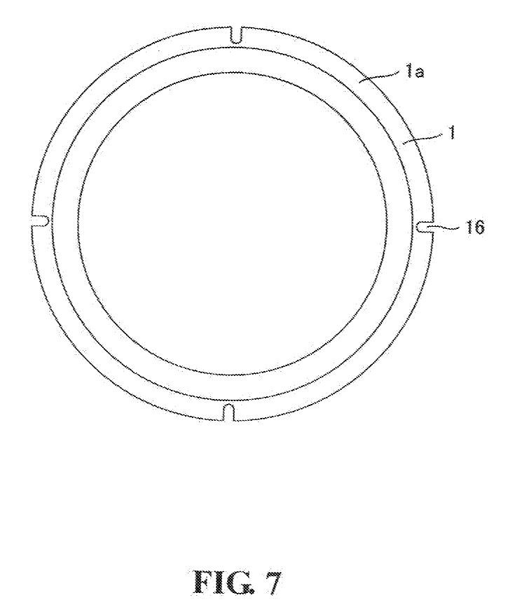

As described above, the cover 1 covers the upper surface of the base 2 including the microphone units 3 and the circuit boards 9. The cover 1 is made of metal like the base 2. Numerous holes through which the sound wave is introduced to the microphone unit 3 are formed on the cover 1. A punching metal on which numerous holes are formed thereon by punching is used as the cover 1 to cover the upper surface of the base 2 in an inverted state. As illustrated in FIG. 7, notches 1b through which the fastening members 13 pass are provided on a plurality of portions on the flange portions 1a of the cover 1. As illustrated in FIG. 3, a receiving portion 2a for the flange 1a of the cover 1 is formed in the periphery of the upper surface of the base 2 having a circular planer shape. Thus, the contact between the peripheral portion of the cover 1 and the base 2 is facilitated. The material and the shape of the cover 2 are not limited to those described above. The shape and the material can be arbitrarily set as long as numerous openings through which sound waves are guided to the microphone unit are formed thereon as shown in FIG. 3.

As described above, the flange 1a of the cover 1 is formed on the entire outer periphery of the cover 1. The surface of the cover 1 is coated except for the surface to be in contact with the base 2, i.e., the bottom surface of the cover 1. Therefore, the cover 1 and the base 2 are electrically connected with each other. The non-coated surface may be formed by not performing coating thereon in the coating process or by removing the coating thereon after the entire surface of the cover 1 is coated. The planer shape of the cover 1 and the base 2 is not limited to circular and can be rectangular or triangular.

The pressing material 5 having a shape of a ring presses the flange portion 1a of the cover 1 at the entire circumference. As illustrated in FIG. 1, the pressing member 5 has a protruding portion 5a that presses the flange portion 1a at the surface facing the flange portion 1a of the cover 1. The protruding portion 5a is formed on the entire outer periphery of the pressing member 5 and has a semicircle cross-sectional shape. The cross-sectional shape of the protruding section 5a can be arbitrarily selected. The protruding section 5a may be formed on the entire outer periphery of the pressing member 5 or may be serially formed on the outer periphery thereof. In terms of pressing effect, the protruding portion 5a is preferably formed on the entire periphery so that the pressure is applied on the entire circumference. The base 2, the cover 1, and the pressing material 5 are integrally fastened by the appropriate fastening members 13. In a boundary microphone, a capacitor microphone unit with an impedance converter is generally used as the microphone unit 3. A tone control circuit, a sound output circuit, and the impedance converter, all of which is not illustrated, are installed on the circuit board 9.

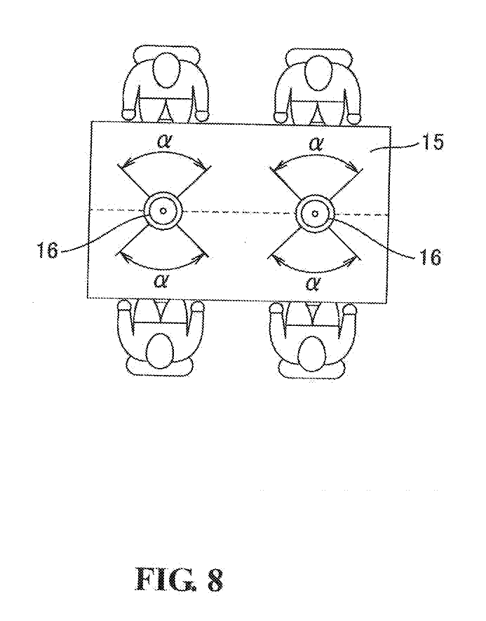

As illustrated in FIG. 6, in the case where the two microphone units 3 held by the two respective microphone unit holders 8 are positioned with the angular interval of 180 degrees, the direction of which the remaining one microphone unit 3 faces is perpendicular to the line connecting the centers of the two microphone units 3. FIG. 8 depicts a state in which boundary microphones 16 with the remaining one microphone unit 3 not held by the microphone unit holder 8 turned off are placed on a table. Here, only the two microphone, units 3 positioned in back to back manner with the angular interval of 180 degrees perform electro-acoustic conversion. The boundary microphones 16 can pick up sound waves in sound pickup angle range of α degrees on both front and back thereof, where α degree is the sound pickup angle range of the microphone units 3. All things considered, the boundary microphone 16 with the above setting may be placed at a center portion of a table 15 in the front-back direction in the case where the participants are seated across the table 15 on the front and back sides.

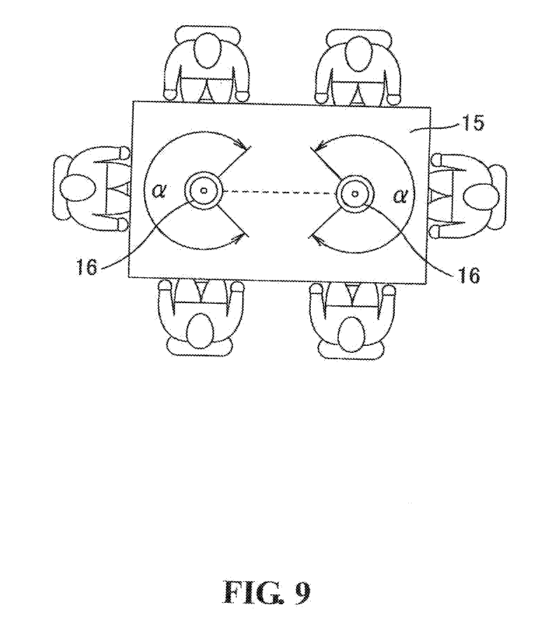

FIG. 9 depicts a state in which the two microphone units 3 held by the two respective microphone unit holders 8 are positioned to have angular interval of 180 degrees in the circumferential direction, and all three microphone units 3 including the remaining one microphone unit 3 are turned on. The two microphone units 3 having angular interval of 180 degrees and the remaining one microphone unit 3 facing the direction perpendicular to the center axis lines of the two microphone units 3 each has a sound pickup range. Therefore, in a conference where the participants are seated around the table 15, the boundary microphone 16 with the above setting can pickup voices from participants seated on front and back sides and on the lateral side by being placed on an end portion of the table 15.

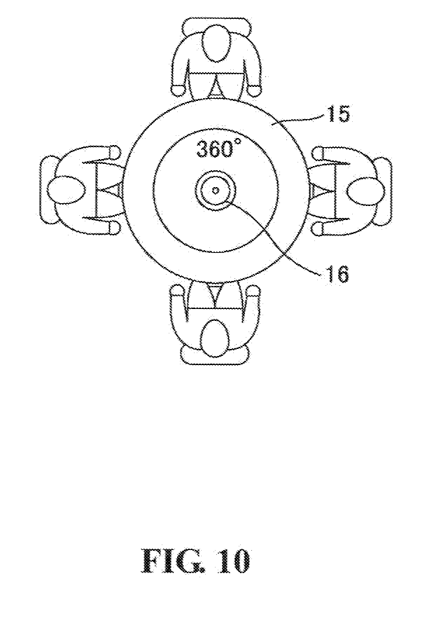

With the three microphone units 3 radially disposed at angular intervals of 120 degrees around the cord insertion hole 11, the sound pickup can be performed on the entire circumferential direction, i.e., 360 degrees in the planer direction as illustrated in FIG. 10. Thus, voices of all the participants seated around this table 15 in FIG. 10 can be picked up.

Anyone can easily adjust the sound pickup range from the outside of the boundary microphone 16 with the microphone unit position changing unit. If the cover 1 has to be removed to adjust the sound collecting range, the adjustment may lead to the breaking of internal components, for example, by accidentally touching the internal components. According to the illustrated embodiment, the user can easily adjust the boundary microphone to have an appropriate sound pickup direction without breaking the component's inside the boundary microphone because the adjustment can be performed from the outside. Thus, no skilled person is required for the adjustment and thereby the maintenance cost can be saved.

The boundary microphone according to the present invention is not limited to the above structure. The microphone unit 3 inside the cover 1 and the base 2 of the boundary microphone can be covered with a shielding member such as a metallic mesh. Further, an appropriate speaker unit can be added to the internal configuration to form a boundary microphone with attached speaker that can solely serve as both sound pickup device and speaker. The boundary microphone with attached speaker may be, for example, placed on a table of a conference room and the like upon use.

What is claimed is:

1. A boundary microphone comprising:
a base made of metal;
a cover that is made of metal and includes a plurality of holes through which a sound wave is guided;
a microphone unit that is disposed on the base and converts sound into an electric signal; and
a pressing material that presses the cover against the base, wherein
the cover has a flange on a peripheral portion, and
the pressing material presses the flange portion of the cover against the base to make the flange portion of the cover surface to surface contact with the base.

2. The boundary microphone according to claim 1, wherein
the flange portion of the cover is formed on an entire periphery of the cover, and
the pressing material presses the flange portion of the cover at an entire circumference of the flange portion.

3. The boundary microphone according to claim 1, wherein the pressing material has a protruding portion at the pressing material's surface which faces to the flange portion of the cover and the protruding portion presses the flange portion.

4. The boundary microphone according to claim 3, wherein the protruding portion of the pressing material is formed on an entire periphery of the pressing material.

5. The boundary microphone according to claim 1, wherein the cover and the base have circular planer shape, and the pressing material has a shape of a ring.

6. The boundary microphone according to claim 1, wherein the base, the cover, and the pressing material are integrally fastened by the fastening member.

7. The boundary microphone according to claim 1, wherein the base is provided with a code insertion hole through which an internal space covered by the cover is communicated into outside, the hole being formed at a center of the base in a planer shape.

8. The boundary microphone according to claim 7, wherein
three such microphone units are provided, and
the three microphone units are radially disposed around the cord insertion hole with angular interval of 120 degrees while center axial lines of the three microphone units are parallel with a surface of the base.

9. The boundary microphone according to claim 1, wherein the cover is formed of a punching plate.

10. The boundary microphone according to claim 9, wherein
the cover is formed of a punching plate with a surface coated while a surface in contact with the base is a non-coated surface.
